(19) United States
(12) Patent Application Publication
(10) Pub. No.: US 2024/0014026 A1
(43) Pub. Date: Jan. 11, 2024

(54) MAGNETIC SECTOR WITH A SHUNT FOR A MASS SPECTROMETER

(71) Applicant: LUXEMBOURG INSTITUTE OF SCIENCE AND TECHNOLOGY (LIST), Esch-sur-Alzette (LU)

(72) Inventor: Hung Quang Hoang, Esch-sur-Alzette (LU)

(21) Appl. No.: 18/042,811

(22) PCT Filed: Aug. 16, 2021
(86) PCT No.: PCT/EP2021/072753

§ 371 Date: Feb. 24, 2023

(30) Foreign Application Priority Data
Aug. 27, 2020 (LU) LU102015

(51) Int. Cl. H01J 49/30; H01J 49/20

(52) U.S. Cl. CPC H01J 49/30; H01J 49/20

(57) ABSTRACT

A magnetic sector including magnetic means, a yoke including a first magnetic portion, and a deflection gap in the first magnetic portion. The magnetic sector is configured such that the magnetic means are adapted for generating a magnetic field through the deflection gap in order to deflect charged particles moving in the deflection gap. The yoke further includes a second magnetic portion having a magnetic shunt including a shunt passage for the charged particles. The magnetic shunt directs a magnetic flux leaked from the deflection gap into the first magnetic portion.

### TECHNICAL FIELD

The invention lies in the field of magnetic sectors. More precisely, the invention provides a magnetic sector with a magnetic shunt. The invention also provides a charged particle deviation process and a use of a yoke.

### BACKGROUND OF THE INVENTION

Mass spectrometry is an analytical technique that is commonly used to determine the elements that compose a molecule or sample. A mass spectrometer typically comprises a source of ions, a mass separator and a detector. The source of ions may for example be a device which is capable of converting the gaseous, liquid or solid phase of sample molecules into ions, that is, electrically non-neutral charged atoms or molecules. Several ionization techniques are well known in the art, and the particular structure of an ion source device will not be described in any detail in the present specification. Alternatively, the ions to be analyzed by the mass spectrometer may result from the interaction between the sample in its gaseous, liquid or solid phase and an irradiation source, such as a laser, ion or electron beam. The ion-emitting sample is in that case considered to be the source of ions.

The ion beam that originates at the ion source is analyzed using a mass analyzer, which is capable of separating, or sorting, the ions according to their mass-to-charge ratio. The ratio is typically expressed as m/z, wherein m is the mass of the analyte in unified atomic mass units, and z is the number of elementary charges carried by the ion. The Lorentz force law and Newton's second law of motion in the non-relativistic case characterize the motion of charged particles in space under electric field and/or magnetic field. Mass spectrometers therefore employ electrical field and/or magnetic field in various known combinations in order to separate the ions created by the ion source. An ion having a specific mass-to-charge ratio follows a specific trajectory in the mass-analyzer. As ions of different mass-to-charge ratios follow different trajectories, the composition of the analyte may be determined based on the observed trajectories. By analogy with an optical spectrometer, which allows generation of a spectrum of the different wavelengths comprised in a wave beam, the mass spectrometer allows generation of a spectrum of the different mass-to-charge ratios comprised in a molecule or sample.

In order to detect the ions various known detection devices may be employed at the exit of the mass analyzer. Such detectors can be position sensitive or not, and are well known in the art. Their functioning will not be further explained in the context of the present specification. In general terms, a detector device is capable of measuring the value of an indicator quantity. It provides data for computing the abundances of each ion present in the analyte.

Sector instruments are a specific type of mass analyzing instruments. A sector instrument uses a magnetic field or a combination of an electric and magnetic field to affect the path and/or velocity of the charged particles. In general, the trajectories of ions are bent by their passage through the sector instrument, whereby light and slow ions are deflected more than heavier fist ions. Magnetic sector instruments generally belong to two classes. In scanning sector instruments, the magnetic field is changed, so that only a single type of ion is detectable in a specifically tuned magnetic field.

By scanning a range of field strengths, a range of mass-to-charge ratios can be detected sequentially. In non-scanning magnetic sector instruments, a static magnetic field is employed. A range of ions may be detected in parallel and simultaneously. The known non-scanning magnetic sector instruments are typically classified as Mattauch-Herzog type mass spectrometers. A Mattauch-Herzog type mass analyzer consists of an electrostatic sector, ESA, followed on the secondary ion trajectories by a magnetic sector. The arrangement of the electrostatic sector and the magnetic sector typically allows to disperse a wide range of mass-to-charge ratios m/z along the exit plane of the magnetic sector. All the ion masses are focused on a focal plane located at the exit plane (in the original Mattauch-Herzog configuration), or at a distance from the exit plane of the magnetic sector.

A magnetic sector typically comprises magnetic means, pole pieces and a yoke, which closes the magnetic circuit in a loop. The yoke and pole-pieces are typically made of soft magnetic materials such as iron or other ferromagnetic alloys. The magnetic flux generated by the permanent magnets follows a closed magnetic circuit formed by the pole-pieces, the yoke and the air gap between the pole-pieces. A magnetic field is typically generated inside the air gap of the sector, and generally presents a uniform field distribution inside the air gap of the sector as well as a fringe field outside the sector.

An ideal magnetic sector provides a uniform magnetic field inside the sector, which should be sharply dropping to zero outside the physical boundary of the sector. Unfortunately, this does not happen in practice. In fact, the magnetic field strength at the physical entrance and the exit boundaries of the sector does not drop sharply from the value inside the air gap to zero outside the air gap. It rather decreases gradually to zero from a distance inside the air gap to a distance outside of the physical boundaries. This long-tail distribution of the leakage magnetic field outside the air gap is called the fringe field or fringing field. This magnetic fringe field typically extends from several millimeters to several centimeters outside of the magnetic sector, depending on the used materials, the size of the magnetic sector, the width of the air gap and the generated magnetic field strength.

This behaviour of the magnetic sector field is commonly undesired in several applications, as it can significantly interfere with other devices placed within the corresponding fringe field area. In a sector field mass spectrometer, a charged particle detection system is commonly used to collect the ions after they exit the magnetic sector in order to form a mass spectrum. The detection system can comprise a single detector, a multi-collector of several single detector, or a focal plane detector. The detectors are typically positioned within the space where the fringe field of the magnetic sector device is not negligible. The presence of the fringe field can affect the detector in different ways. The fringe field can generate artificial peaks on the mass spectrum. Indeed, the interaction of an ion beam with the detector medium generates the secondary electron emission, which escapes the detector surface and is circulated back to the detector surface under the influence of the magnetic fringe field. This secondary electron emission can create an artificial peak or background noise on the detected mass spectrum.

Further, the fringe field can affect the operation of the detector and other devices. In known detectors, which are based on the use of electron multiplying principle such as in the channeltron (CEM) or microchannel place (MCP) detectors, the magnetic field can influence on their pre-amplification property. Both the CEM and MCP are based on the same principle of pre-amplifying the detected charged particle (or light) signal by multiplying the electron secondary emission generated from the interaction of the incident particle along a high aspect-ratio channel. The presence of a magnetic field can influence on the motions of the multiplied electron emission and therefore on the amplification property of the detectors. Moreover, a strong magnetic field present in the space between the CEM/MCP and the anode can prevent the electron cloud from the CEM/MCP channels from reaching the anode. This could cause the loss in the detection capability of the detector.

### Technical Problem to be Solved

It is an objective of the invention to present a device, which overcomes at least some of the disadvantages of the prior art. In particular, it is an objective of the invention to improve the measurement accuracy. It is also an objective of the invention to reduce magnetic flux spreading outside a magnetic sector.

### SUMMARY OF THE INVENTION

According to an aspect of the invention, it is provided a magnetic sector. The magnetic sector comprising: magnetic means, a yoke including a first magnetic portion, and a deflection gap in the first magnetic portion; the magnetic sector being configured such that the magnetic means are adapted for generating a magnetic field through the deflection gap in order to deflect charged particles moving in said deflection gap, wherein the yoke further comprises a magnetic shunt including a shunt passage for the charged particles, said magnetic shunt being configured for directing a magnetic flux leaked from the deflection gap into the first magnetic portion. In accordance with an aspect of the invention, a magnetic sector is provided. The magnetic sector comprises magnetic means, a yoke including a first magnetic portion, and a second portion comprising a magnetic shunt. The magnetic sector further comprises a deflection gap in the first magnetic portion. The the magnetic sector is configured such that the magnetic means are adapted for generating a magnetic field through the deflection gap in order to deflect charged particles moving in said deflection gap. The magnetic shunt comprises a shunt passage for the charged particles to pass across the magnetic shunt, and the magnetic shunt is arranged for directing a magnetic flux leaked from the deflection gap into the first magnetic portion.

Preferably, the magnetic sector further defines an opposite face at the opposite of the inlet face, wherein the magnetic sector further comprises a third magnetic shunt at the opposite face, the third magnetic shunt optionally being symmetrical to the inlet shunt.

Preferably, the magnetic shunt may be arranged at distance from and/or faces the first magnetic portion.

Preferably, the magnetic sector, notably the yoke, may comprise magnetic connection means magnetically coupling the magnetic shunt to the first magnetic portion. Preferably, the magnetic sector or the yoke may comprise magnetic connection means for magnetically coupling the magnetic shunt to the first magnetic portion.

Preferably, the ratio of the width of the deflection gap divided by the thickness of the magnetic shunt may be of at least: 2, or 4; the thickness of the magnetic shunt optionally ranging from: 0.1 mm to 5 mm, or from 0.3 mm to 3 mm.

Preferably, the magnetic sector may comprise an inner separation between the first magnetic portion and the magnetic shunt, the inner separation extending between the deflection gap and the shunt passage, the inner separation optionally separating the deflection gap from the shunt passage.

Preferably, the ratio of the inner width of the inner separation divided by the thickness of the magnetic shunt may be of at least: 2, or 4; said ratio being of at most: 10, or 15. Preferably the inner separation is, or defines, a hollow, or a cavity within the magnetic sector.

Preferably, the inner width of the inner separation may range from: 1 mm to 10 mm, or from 2 mm to 6 mm.

Preferably, the magnetic shunt may comprise at least one magnetic plate, preferably two coplanar magnetic plates, which may be perpendicular to the deflection gap, said at least one magnetic plate, respectively the two coplanar magnetic plates, the defining the shunt passage.

Preferably, the magnetic shunt comprises at least one branch which may be inclined with respect to the at least one magnetic plate and which extends toward the deflection gap, preferably the magnetic shunt may comprise two branches, each of said branch extending from one of the two coplanar magnetic plates toward the deflection gap.

Preferably, the inclination angle α between the at least one branch and the at least one magnetic plate may range: from 10° to 90°, or from 30° to 80°, or from 45° to 60°.

Preferably, the magnetic means may comprise at least one permanent magnet and/or at least one coil.

Preferably, the coil may extend on a majority of a space between the first magnetic portion and the magnetic shunt.

Preferably, the magnetic sector may define an inlet face, and an outlet face, the magnetic shunt may be arranged at the inlet face or at the outlet face of the magnetic sector; or the magnetic shunt may be a first magnetic shunt, arranged at the outlet face and the magnetic sector may further comprise a second magnetic shunt at the inlet face, said second magnetic shunt may be configured for directing a magnetic flux leaked from the deflection gap in the first magnetic portion, and/or the second magnetic shunt may be operatively connected to the first magnetic portion.

Preferably, the yoke may comprise a main magnetic loop in the first magnetic portion and at distance from the magnetic shunt, and an auxiliary magnetic loop through the magnetic shunt and the first magnetic portion.

Preferably, the magnetic sector may comprise two pole pieces, the deflection gap being between said two pole pieces.

Preferably, the inner width of the shunt passage may represent from: 100% to 150%, or 80% to 200%, optionally 100% of the inner width of the deflection gap.

Preferably, the yoke and the magnetic shunt comprise a similar magnetic material such iron or ferromagnetic material, the pole piece optionally comprising said magnetic material, and the width of the deflection gap is equal to the width of the shunt passage.

Preferably, the magnetic sector may comprise a particle passage which may extend the deflection gap through the magnetic shunt.

Preferably, the deflection gap may be a particle passage and/or a particle path.

Preferably, the yoke may be one-piece and/or includes stacked magnetic sheets.

Preferably, the yoke and the magnetic means may be configured for generating a magnetic field in the deflection gap in order to deviate a charged particle such as an ion.

Preferably, the magnetic sector may be adapted for deviating charged particles by means of the magnetic field within the air gap depending on their mass-to-charge ratios.

Preferably, the magnetic shunt may face the magnetic means, notably along a particle path.

Preferably, the magnetic shunt may be an outer shunt outside the first magnetic portion.

Preferably, the magnetic connection means may magnetically and/or physically connect the at least one plate to the first magnetic portion.

Preferably, the first magnetic portion may be a main magnetic portion and/or a main magnetic body of the yoke.

Preferably, the magnetic shunt may be symmetric; notably with respect to a deflection gap middle plane.

Preferably, the magnetic shunt may be integrated in the yoke, and/or integrally formed with the yoke.

Preferably, the magnetic means may comprise at least two magnetic units, the deflection gap may extend between said two magnetic units.

Preferably, the inner separation may be in contact of the magnetic shunt and of the first magnetic portion, and optionally of the pole piece(s) and the magnetic means.

Preferably, the yoke may comprise an inner separation between the first magnetic portion and the magnetic shunt.

Preferably, the magnetic sector may comprise a particle recess for charged particles, said particle recess being configured such that said charged particles cross the magnetic sector by means of said particle recess, the inner separation and the deflection gap being part of said particle recess.

Preferably, the magnetic shunt may comprise a flat edge or a ledge delimiting the shunt passage.

Preferably, the yoke may be a magnetic yoke comprising a magnetic material, notably a ferromagnetic material.

Preferably, the yoke may comprise two bordering portions between which the deflection gap is interleaved, and a bridge portion connecting said two bordering portions, the magnetic shunt being adjacent said two bordering portions.

Preferably, the yoke may comprise a main magnetic circuit within the first magnetic portion.

Preferably, the yoke may comprise at least one auxiliary magnetic circuit through the shunt and the yoke.

Preferably, the auxiliary magnetic loop(s) may cross the deflection gap and the shunt passage.

Preferably, the minimum section or the average section of the first magnetic portion may be larger, preferably at least two times, more preferably at least four times, larger than the minimum section; respectively the average section; of the magnetic shunt.

Preferably, the magnetic shunt may be adjacent to, and/or faces the first magnetic portion.

Preferably, the first magnetic portion is the main magnetic portion or the main body of the yoke.

The fact that the magnetic shunt is configured for directing a magnetic flux, notably a fringe field, at the deflection gap in the first magnetic portion is not an essential aspect of the invention. The magnetic shunt may be operatively connected to the first magnetic portion. The first magnetic portion is not an essential feature of the invention. It may be replaced by a main body of the yoke.

It is another aspect of the invention to provide a magnetic system, such as a magnetic sector, notably for a mass spectrometer, the magnetic system comprising:
a main magnetic circuit including a deflection gap, such as an air gap, for moving charged particles,
magnetic means adapted for generating a magnetic field in the main magnetic circuit in order to deflect the charged particles moving through the deflection gap, the magnetic system further comprising:
a shunt passage; and
a magnetic shunt circuit within a yoke, and which crosses the shunt passage and the deflection gap and/or which joins the shunt passage to the deflection gap.

It is another aspect of the invention to provide a particle deviation system comprising:
a main magnetic core, such as a first magnetic portion of a yoke, with an inner passageway through which charged particles are deviated depending on the charges of said particles, for instance depending on the mass to charge ratios of the particles,
magnetic source means adapted for generating a magnetic field within the main magnetic core and notably through the inner planar path in order to deviate said electrically loaded particles,
a second magnetic portion comprising a magnetic shunt adjacent the planar path and magnetically coupled to the main magnetic core.

It is another aspect of the invention to provide a magnetic sector comprising:
a yoke with a first magnetic portion,
a deflection gap arranged in the first magnetic portion,
magnetic means configured for generating a magnetic field through the deflection gap where charged particles are intended to move,
the yoke further comprising:
a magnetic shunt including a shunt passage for the charged particles,
a magnetic connection interface between the first magnetic portion and the magnetic shunt.

It is another aspect of the invention to provide a magnetic sector mass spectrometer comprising: an ion source, an electrostatic sector, a magnetic sector mass analyser, and at least one detection system, wherein the magnetic sector mass analyser is a magnetic sector in accordance with aspects of the invention.

Preferably, the distance between the detection system and the shunt may be of at most: 100 mm, or 50 mm, or 30 mm.

It is another aspect of the invention to provide a charged particle deviation process, notably a mass to charge ratio measuring process, the process comprising the steps: providing a magnetic sector including a yoke enclosing a first magnetic portion, and a deflection gap in the first magnetic portion; providing a second magnetic portion comprising a magnetic shunt magnetically coupled to the first magnetic portion, generating a magnetic field through the deflection gap, moving a charged particle through the deflection gap, deflecting the charged particle in the deflection gap by means of the magnetic field, crossing the magnetic shunt with the charged particle outside the first magnetic portion; the magnetic sector notably being in accordance with the invention.

In accordance with a further aspect of the invention, a charged particle deviation process, notably a mass to charge ratio measuring process is provided. The process comprises the steps:
providing a magnetic sector in accordance with an aspect of the invention;
generating a magnetic field through the deflection gap;
moving a charged particle through the deflection gap;
deflecting the charged particle in the deflection gap by means of the magnetic field;
crossing the magnetic shunt with the charged particle outside the first magnetic portion.

Preferably, the process may comprise a step entering the yoke during which the charged particle crosses the magnetic shunt, and/or the process comprises a step leaving the yoke during which the charged particle crosses the magnetic shunt.

Preferably, at step crossing, the magnetic field in the shunt may represent at most 5% of the magnetic field in the yoke.

It is another aspect of the invention to provide a process for reducing magnetic flux leaked from a yoke of a magnetic sector, wherein the process comprises the steps:
providing a magnetic sector including a yoke defining a first magnetic portion, and a deflection gap in the first magnetic portion;
generating a magnetic field through the deflection gap in order to deviate charged particles traversing the deflection gap;
providing a magnetic shunt with a shunt passage, said magnetic shunt channeling a magnetic field to the first magnetic portion of the yoke,
the magnetic sector notably being in accordance with the invention.

It is another aspect of the invention to provide a use of a yoke portion for forming a magnetic shunt for a yoke of a magnetic sector, notably for a sector-field mass spectrometer, the yoke enclosing a first magnetic portion and a deflection gap through the first magnetic portion, the magnetic sector comprising magnetic means, the magnetic sector being configured such that the magnetic means are adapted for generating a magnetic field in the deflection gap in order to deviate charged particles traversing said deflection gap, the magnetic shunt exhibiting a shunt passage communicating with the deflection gap, the magnetic sector notably being in accordance with the invention.

Preferably, the magnetic shunt may comprise a magnetic element which is used for magnetically connecting the shunt passage to the first magnetic portion of the yoke.

It is another object of the invention to provide a use of a portion of the yoke for reducing fringe field and/or magnetic flux leaked from the deflection gap of a magnetic sector, the yoke including a first magnetic portion, a magnetic shunt portion, and a deflection gap through the first magnetic portion, the magnetic sector comprising magnetic means adapted for generating a magnetic field in order to deviate charged particles moving in said deflection gap, the magnetic shunt portion exhibiting a shunt passage at distance from with the deflection gap, the magnetic sector notably being in accordance with the invention.

Preferably, the magnetic element comprises the connection means.

The different aspects of the invention may be combined to each other. In addition, the preferable features of each aspect of the invention may be combined with the other aspects of the invention, unless the contrary is explicitly mentioned.

### Technical Advantages of the Invention

The invention reduces the extent or the propagation of fringe fields generated by a magnetic sector. Magnetic flux leaking from the air gap, through which charged particles pass in order to be deflected in accordance with their mass-to-charge ratio, is intercepted and captured by the shunt, then injected back to the yoke directly. Consequently, the deviation involved by the magnetic sector becomes closer to an ideal model, wherein the fringe field is non-existent or minimal. The deflection process is easier to control, and the measured mass-to-charge ratio are more accurate.

The phenomenon of artificial peaks at detectors is reduced. The influence of the magnetic fringe field from the magnetic sector on other devices is reduced.

The choice of the thicknesses and widths offers a compromise between the magnetic efficiency and compactness of the magnetic sector.

### BRIEF DESCRIPTION OF THE DRAWINGS

Several embodiments of the present invention are illustrated by way of figures, which do not limit the scope of the invention, wherein

FIG. 1 provides a schematic illustration of a spectrometer device in accordance with a preferred embodiment of the invention;

FIG. 2 is a through cut along line 2-2 drawn in FIG. 1 of a magnetic sector in accordance with a preferred embodiment of the invention;

FIG. 3 is a through cut along line 3-3 drawn in FIG. 1 of a magnetic sector in accordance with a preferred embodiment of the invention;

FIG. 4 is a through cut along line 2-2 or line 3-3 drawn in FIG. 1 of a magnetic sector in accordance with a preferred embodiment of the invention;

FIG. 5 is a graph of the magnetic flux variation along a particle beam deviated by a magnetic sector in accordance with a preferred embodiment of the invention;

FIG. 6 is a graph of the magnetic flux variation in and out a magnetic sector in accordance with a preferred embodiment of the invention;

FIG. 7 is a diagram block of a charged particle deviation process in accordance with a preferred embodiment of the invention.

### DETAILED DESCRIPTION OF THE INVENTION

This section describes the invention in further detail based on preferred embodiments and on the figures. Similar reference numbers will be used to describe similar or the same concepts throughout different embodiments of the invention.

It should be noted that features described for a specific embodiment described herein may be combined with the features of other embodiments unless the contrary is explicitly mentioned. Features commonly known in the art will not be explicitly mentioned for the sake of focusing on the features that are specific to the invention. For example, the spectrometer device in accordance with the invention is evidently powered by an electric supply, even though such supply is not explicitly referenced on the figures nor referenced in the description.

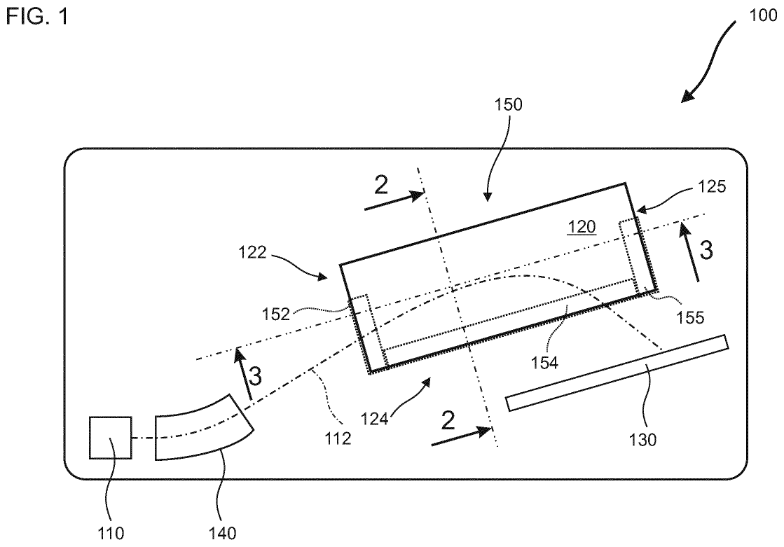

FIG. 1 gives a schematic illustration of a spectrometer device 100 according to a preferred embodiment of the present invention.

The device 100 provides an enclosure having an inlet (not shown) for introducing a sample that is to be analyzed by the technique of mass spectrometry. The enclosure encompasses a vacuum and comprises an ion source 110, a magnetic sector 120 and at least one detector 130. Throughout this description, the word detector will be used to denote a device that is capable of detecting and quantifying ions of different mass-to-charge ratios, to compute the resulting spectrum and to display the resulting spectrum. Such devices or device assemblies are well known in the art. An optional electrostatic sector 140 may be provided between the ion source 110 and the magnetic sector 120. Then, along the ion beam 112 the electrostatic sector 140 is downstream the ion source 110, and upstream the magnetic sector 120.

The ion source 110, or source of ions, generates the ion beam 112 which reaches the entrance plane, also designated as inlet face 122 of the magnetic sector 120 at an angle after having passed through the drift space between the ion source and the inlet face 122. The magnetic sector generates a magnetic field, which causes the ions to follow specifically curved trajectories, depending on their specific mass-to-charge ratios m/z.

In the current embodiment, the magnetic sector 120 generally exhibits a rectangular shape. However, the magnetic sector may also have a generally curved shape on one side, which is opposed to the side that comprises the ion outlet face 124, also designated as exit plane. A magnetic sector 120 is understood as a magnetic circuit, which is able to provide a magnetic field distribution within an air gap sector. The magnetic sector 120 may further comprise a so-called opposite face 125, also designated as third face. The opposite face 125 is adjacent to the outlet face 124. It may be at the opposite of and/or symmetric to the inlet face 122. The outlet face 124 extends from the inlet face 122 to the opposite face 125.

In order to control and to mitigate the magnetic flux escaping from the magnetic sector 120, shunt means 150 are provided. The shunt means 150 includes an inlet shunt 152 at the inlet face 122, and/or an outlet shunt 154 at the outlet face 124. The distance between the shunts, for instance the outlet shunt 154, is 4 cm. It may be understood that the shunt means 150 are integrated in the magnetic sector 120. The shunt means 150 may further comprise a third shunt 155 at the opposite face 125. The third shunt 155 may be similar to the inlet shunt 152. The third shunt 155 may be symmetric to the inlet shunt 152. It is configured for prevent the fringe field from influencing any other devices placed close to the magnetic sector 120.

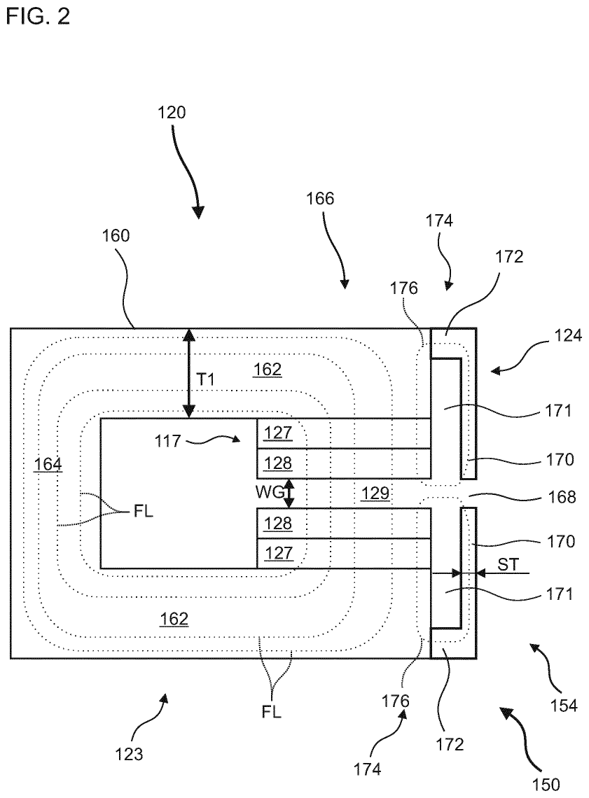

FIG. 2 illustrates a preferred design of the magnetic sector 120. The magnetic sector is represented with a through cut along line 2-2 drawn in FIG. 1. In the current illustration, the outlet face 124 is arranged on the right-hand.

The instrument comprises a yoke 160 that holds magnets 127 and pole pieces 128. More generally, the yoke 160 is a magnetic core or a magnetic assembly. The yoke may comprise several metal sheets forming a laminate wherein the sheets are placed against one another in order to describe a row extending perpendicularly to the current view. Thus, the current cross section of the first magnetic portion 166 may correspond to one of the sheets. The first magnetic portion 166 may correspond to the main portion, or the main body of the yoke 160.

The arrangement of the magnets 127 and the pole pieces 128 is such that from outside to inside, the magnets are followed by the pole pieces. In between the central pole pieces 128, there is a gap space 129, also designated as deflection gap 129. Ions entering the magnetic sector through the entrance plane 122 and exiting the magnetic sector through the outlet face 124, travel in the deflection gap space 129.

In combination with the yoke 160, the magnets 127 and pole pieces 128 form a magnetic circuit and generate a strong magnetic field inside the deflection gap 129 between the pole pieces 128. The magnetic circuit, also designated as magnetic loop, may be considered as main magnetic circuit 123 of the magnetic sector 120. Several illustrative flux lines FL are represented in the main magnetic circuit 123. The main magnetic circuit 123, also designated as first magnetic circuit, is encapsulated in the first magnetic portion 166.

The magnets 127 may be permanent magnets. Preferably, Neodymium-Iron-Boron magnets with a high maximum energy product of at least 40 MGOe (320 kJ/m³) are used in order to reduce the mass of the magnets. In a preferred embodiment, the thickness of the magnets 127 is of 6 mm. The pole pieces 128 have a preferred thickness of 6 mm in order to maintain the uniformity of the magnetic field in the deflection gap 129. Neodymium Iron Born magnets with a maximum energy product of 45 MGOe is used. The magnets 127 may be replaced by any suitable magnetic means 117.

By way of illustration, the yoke 160 has a thickness T1 of 15 mm. In order to minimize the fringing field region near the edge of the magnetic sector, pure iron, which has a high permeability, is employed for both the yoke and the pole pieces. The deflection gap 129 has a width WG of preferably 4 mm. The maximum magnetic field that may be achieved with the preferred design in the gap between the pole pieces is of 0.58 T.

The yoke 160 may generally comprise a “U” shape, or a “U” cross section. The yoke 160 exhibits bordering portions 162, and a bridge portion 164 connecting the bordering portions 162. The latter support the pair of magnets 127 between which the pole pieces 128 are interleaved. The bordering portions 162 are parallel to each other, and to the deflection gap 129; whereas the bridge portion 164 is perpendicular. The bridge portion 164 may be as thick as the bordering portions 162, and exhibit the thickness T1. The yoke 160 defines a first magnetic portion 166. The bordering portions 162, and possibly the bridge portion 164, are part of the first magnetic portion 166. The first magnetic portion 166 forms the main body of the yoke 160.

The yoke 160 comprises a second magnetic portion which is separate and distinct from the first magnetic portion 166. The second magnetic portion forms or comprises the outlet shunt 154 of the shunt means 150. The outlet shunt 154 physically forms the outlet face 124 of the magnetic sector 120. It forms an end wall thereon. Since the shunt is part of the yoke, it may be deduced that a portion of the yoke is used for forming a shunt.

The shunt 154 faces the magnets 127 and the pole pieces 128. It preferably extends all along the deflection gap 129. The outlet shunt 154 is parallel to the bridging portion 164. The shunt 154 protrudes from the first magnetic portion 166, notably from the bordering portions 162. The shunt 154 defines a shunt passage 168, opening or through-hole, for the particles to escape across the shunt 154 from the magnetic sector 120. The shunt passage 168 is in communication with the deflection gap 129. The shunt passage allows charged particles to pass from a first side of the shunt, inside the magnetic sector, to a second opposite side of the shunt, to the outside of the magnetic sector. The shunt passage allows charged particles to pass through the shunt. They present similar or identical widths, for the instance the width gap WG. The shunt passage 168 forms a slot through the shunt 154, which may extend at least partially along the outlet face 124. The shunt passage 168 defines an opening for the charged particles projected outside the magnetic sector 120.

The shunt 154 comprises at least one magnetic plate 170, preferably two magnetic plates 170. Thus, the shunt 154 is formed of two magnetic elements, each associated with one of the bordering portions 162. The magnetic plates 170 are made of magnetic material. The magnetic plates 170 are parallel and coplanar. The magnetic plates 170 include parallel edges facing each other, and which demarcate the shunt passage 168. The plates 170 mask the magnets 127, the pole pieces 128 and the ends of the bordering portions 162.

The shunt 154 comprises inner separations 171. The inner separations 171 span along the plates 170. The inner separations define a hollow, or cavity, a volume within the magnetic sector. On the opposite side, the boundaries or walls of the inner separations 171 are defined by the magnets 127, the pole pieces 128 and the tips of the bordering portions 162. The width of the inner separations 171 is larger, for instance at least two times larger than the thickness ST of the shunt 154. The thickness ST of the shunt 154 corresponds the thickness of the plates 170 since they form the main part of the shunt 154. The thickness T1 of the first magnetic section, notably of the bordering portions 162, is at least: five, or ten times larger than the thickness ST of the shunt 154.

The shunt 154 further comprises connection means 172 enabling a magnetic connection between the shunt 154 and the first magnetic portion 166. More precisely, the connection means 172 physically connect the magnetic plates 170 to the bordering portions 162. The connection means 172 comprise a magnetic material. They may be integral with the plates 170. The connection means 172 project from the plates 170 to the first magnetic portion 166. Thus, auxiliary magnetic circuits 174 are formed in combination with the bordering portions 162. These auxiliary magnetic circuits 174 are formed above and below the deflection gap 129. The auxiliary magnetic circuits 174 encircle the inner spaces 171. Then, magnetic flux lines 176 escaping from the deflection gap 129 are caught by free ends of the plates 170. Accordingly, this fringe field does not extend away from the magnetic sector, and the deflection process of the charged particles remains under control. Parasite behaviour is limited.

The yoke 160 may comprise fixation means for the shunt. The fixation means may comprise screw passing through the connection means 172 and extending within the first magnetic portion 166.

In the current embodiment, the features defined in relation with the outlet shunt 154 also apply to the inlet shunt of the shunt means 150. The inlet shunt and the outlet shunt may be similar.

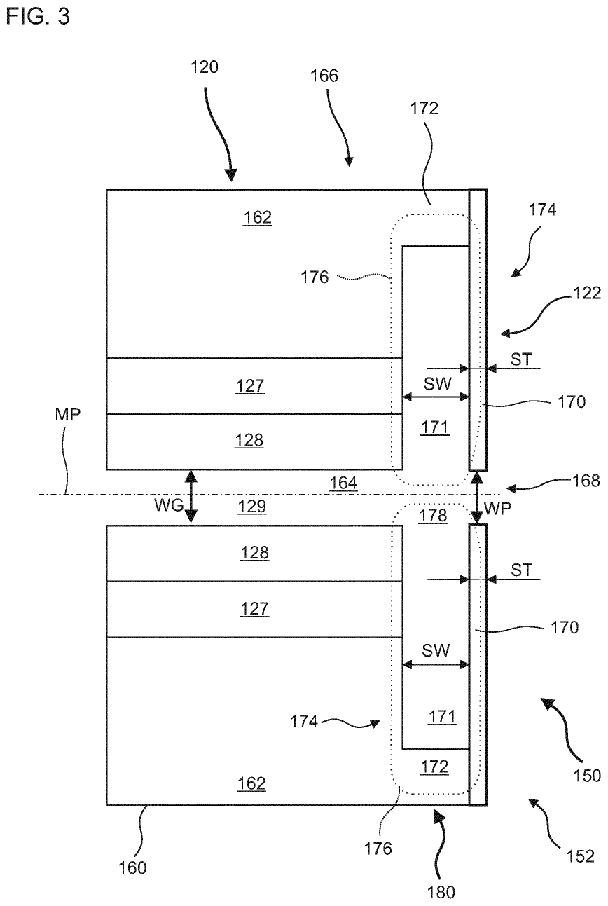

FIG. 3 provides a detail view of the inlet shunt 152 of the shunt means 150 in accordance with a preferred embodiment of the invention. The current view corresponds to a through cut along the line 3-3 apparent in FIG. 1. The yoke 160 is partially represented. The represented area is at the inlet face 122 of the magnetic sector 120.

In the current cross section, the first magnetic portion 166 is partially represented. Starting from the deflection gap 129, a pole piece 128, a magnet 127 and a bordering portion 162 are provided at the upper side and the lower side of said gap 129. Then, the magnets 127, the pole pieces 128 and the bordering portions 162 form an upper laminate above the deflection gap 129, and lower one. The bridging portion 164 is in the background, and is apparent through the deflection gap 129.

The yoke 160 may comprise another second magnetic portion, which may also be referred to as a third magnetic portion. The third magnetic portion is separate and distinct from the first magnetic portion 166, and from the outlet shunt. The third magnetic portion forms the inlet shunt 152 of the shunt means 150. The inlet shunt 152 physically forms the inlet face 122 of the magnetic sector 120. It forms an end wall or side wall. The shunt is integrated in the yoke such that one of its used for creating a shunt.

The shunt 152 is symmetric respect to a deflection gap middle plane MP. The middle plane MP may be at mid width, or mid height, of the deflection gap 129. The shunt 152 faces the magnets 127 and the pole pieces 128. It extends all along the deflection gap 129. The inlet shunt 152 forms a plane which is inclined with respect to, or perpendicular to, the bridging portion 164. The shunt 152 extends from the first magnetic portion 166, notably from the bordering portions 162. The shunt 152 defines a shunt passage 168, through-hole or opening for the particles entering the magnetic sector 120. The shunt passage 168 may form a slot through the shunt 152. The shunt passage 168 spans along the inlet face 122. The shunt passage allows the charged particles to pass across the inlet shunt, from the outside of the magnetic sector to the inside.

The shunt 152 comprises at least one magnetic plate 170 having an opening such as a slit extending over a part of its length, or alternatively preferably two magnetic plates 170 above one another. In the latter option, the shunt 152 encloses two other magnetic elements, each associated with one of the bordering portions 162. The magnetic plates 170 are made of magnetic material. The magnetic plates 170 are parallel and coplanar. The magnetic plates 170 include parallel edges parallel to the deflection gap 129, and bordering the shunt passage 168. Then, the shunt means 150 with the inlet and outlet shunt comprises four plates 170 and two passages 168.

The shunt 152 comprises inner separations 171. The inner separations 171 deepen in the yoke 160. The inner separations 171 are connected by a particle recess 178. In other words, the yoke 160 defines a continuous particle recess 178, such as a free space, which encloses the deflection gap 129 and the shunt passage 168. The particle recess 178 allows charged particle motion, from the inlet face to the outlet face.

The inner separations 171 touches the magnets 127, the pole pieces 128 and the tips of the bordering portions 162. The inner width SW, or separation width SW, of the inner separations 171 is larger, for instance at least: two, or four, or six, or twelve, times larger than the thickness ST of the shunt 152, notably of the plates 170.

The yoke 160 further comprises connection means 172 enabling a magnetic connection between the shunt 152 and the first magnetic portion 166. More precisely, the connection means 172 physically connect the magnetic plates 170 to the bordering portions 162. The connection means 172 comprise a magnetic material. They may be integral with the bordering portions 162. The connection means 172 protrude from the bordering portions 162 to the plates 170. In the current illustration, the plates 170 cover the bordering portions 162, and may be screwed thereon. In an alternative, the connections means are part of the shunt, as described in FIG. 2.

The yoke 160 defines an interface 180, such as a magnetic interface 180. The magnetic interface 180 is between the shunt means 150 and the bordering portions 162. The connection means 172 are disposed at said interface 180. The interface 180 magnetically plugs the shunt to the first magnetic portion.

Thus, auxiliary magnetic circuits 174 are formed in combination with the bordering portions 162. These auxiliary magnetic circuits 174 are formed above and below the deflection gap 129. The auxiliary magnetic circuits 174 encircle the inner spaces 171. Then, magnetic flux lines 176 escaping from the deflection gap 129 enter in the plates 170 at their free ends. Accordingly, this fringe field is blocked, and the propagation of fringe fields is prevented.

The thickness ST of the shunt 152 is smaller than the width WG of the deflection gap 129. A ratio of the width WG divided by the thickness ST is of at least: 2 or, 4, or 6, or 10, or 20. This ratio may be comprised between: 2 and 40, or 4 and 20, or 5 and 12; values included. The thickness ST of the magnetic shunt 152 may range from: 0.10 mm to 5.00 mm, or from 0.30 mm to 3.00 mm. The width WG of the deflection gap 129 is similar or equal to the width WP of the shunt passage 168. The magnetic shunt 152 is thinner than the inner width 171. A ratio of the width SW of the inner separation 171 divided by the thickness ST of the magnetic shunt 152 is of at least: 2, or 4, or 10. This ratio may be smaller than: 30, or 20, or 15, or 10, or 8; values included.

A thin shunt, as compared to the gap width, the separation width, or the thickness T1 of the bordering portions 162; promotes the magnetic saturation therein. Thus, it is possible to control the proportion of magnetic flux in the main and the auxiliary magnetic circuit.

The teaching detailed above in relation with the inlet magnetic shunt 152 is transposed to the outlet magnetic shunt.

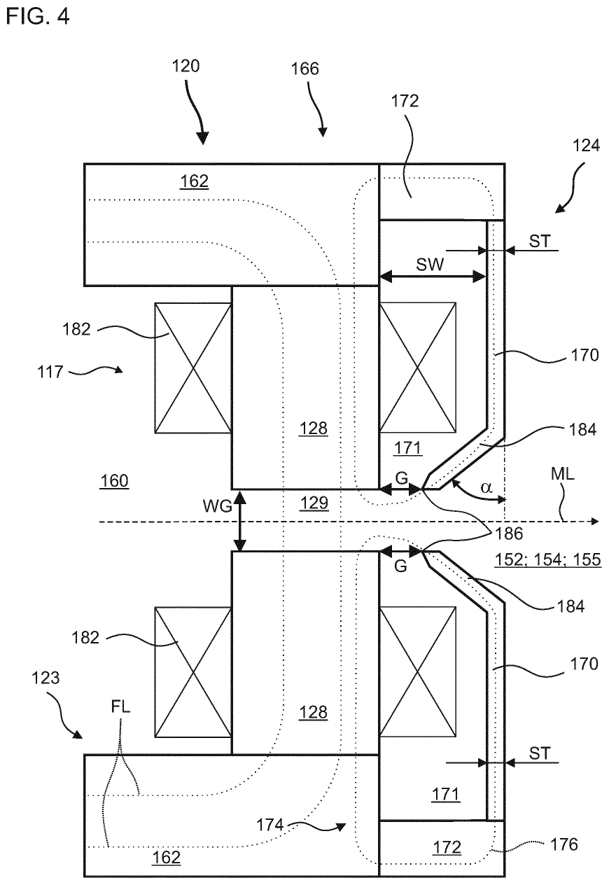

FIG. 4 illustrates another preferred design of the magnetic sector 120. The magnetic sector 120 is represented with a through cut along line 2-2 drawn in FIG. 1. In the current illustration, the outlet face 124 is arranged on the right side. In a non-limitative way, the below teaching also applies to the inlet face and the opposite face. The teaching can apply to the inlet magnetic shunt 152, to the outlet magnetic shunt 154 and the third magnetic shunt 155 of the shunt means 150 described in previous embodiments.

The current shunt 152, 154, 155 may be similar to those described in relation with any of FIGS. 1 to 3, and combinations thereof. The magnetic sector 120 is partially represented. It results that the same applies to the first magnetic portion 166. Only segments of the bordering portions 162 are represented, and are adjacent to the shunt 152, 154, 155.

In the current illustration, the magnetic means 117 comprise coils 182. The coils 182 are between the bordering portions 162; above and under the deflection gap 129. The coils are winded around the poles 128 which act as magnetic cores, and which also as form the air gap to provide a magnetic field therein.

When the coils 182 are electrically powered, the coils 182 generate a magnetic flux in the yoke 160, and notably in the main magnetic circuit 123, also defining a main magnetic loop 123. Flux line FL are within the main magnetic circuit 123. In the meantime, leakage flux escapes the main magnetic circuit 123 at the deflection gap 129. This is represented by the secondary flux lines 176.

These secondary flux lines 176 are enclosed in the auxiliary magnetic circuits 174. The secondary flux lines 176 go around the deflection gap 129; and span in the magnetic plates 170, in the connection means 172, and in the first magnetic portion 166. The secondary flux lines 176 define rings crossing the coils 182. Along the middle line ML, which is at mid height of the deflection gap 129, the magnetic flux significantly decreases outside the magnetic sector 120. Detectors in the vicinity of the magnetic sector are not disturbed by parasite magnetic flux. Detected auxiliary peaks are limited or prevented.

As apparent from the current illustration, the coils extend over at least 50% of the width SW of the inner space 171, notably between the plates 170 and the first magnetic portion 166. In other words, the coil extends on a majority of a space between the first magnetic portion 166 and the shunt 152. 154. 155. The width SW of the inner space 171 may be larger, for instance at least: 2 or 3, times larger than the width WG of the deflection gap 129.

In the current embodiment, the shunt 152. 154. 155 comprises branches 184, also designated as wings 184. The branches 184 are at the ends of the magnetic plates 170 which are toward each other. Each branch 184 is inclined with respect to the associated plate 170. Each branch 184 may form a deviation with an angle α with respect to the corresponding plate 170. The angle α may range from: 10° to 80°, or 30° to 60°.

The branches 184 comprise edges 186 pointing toward the deflection gap 129. The gaps G comprise lengths which are larger than the thickness ST of the shunt 152. 154. 155. The shunt thickness ST is at least: 2, or 4 times smaller than the gaps G.

The plates 170 join the branches 184 to the connection means 172. The connection means 172 may be separated and distinct from: the bordering portions 162, and, the plates 170. In the current illustration, the connection means 172 exhibits a rectangular cross section. However, they may have different shapes. The connection means 172 are attached at edges of the plates 170 which are opposed to the branches 184. Thus, different magnetic materials may be chosen. The assembling method and setting may be easier when different steps exist.

As an alternative, the connections means are part of the shunt, of the first magnetic portion, as described in FIG. 2 and FIG. 3 respectively.

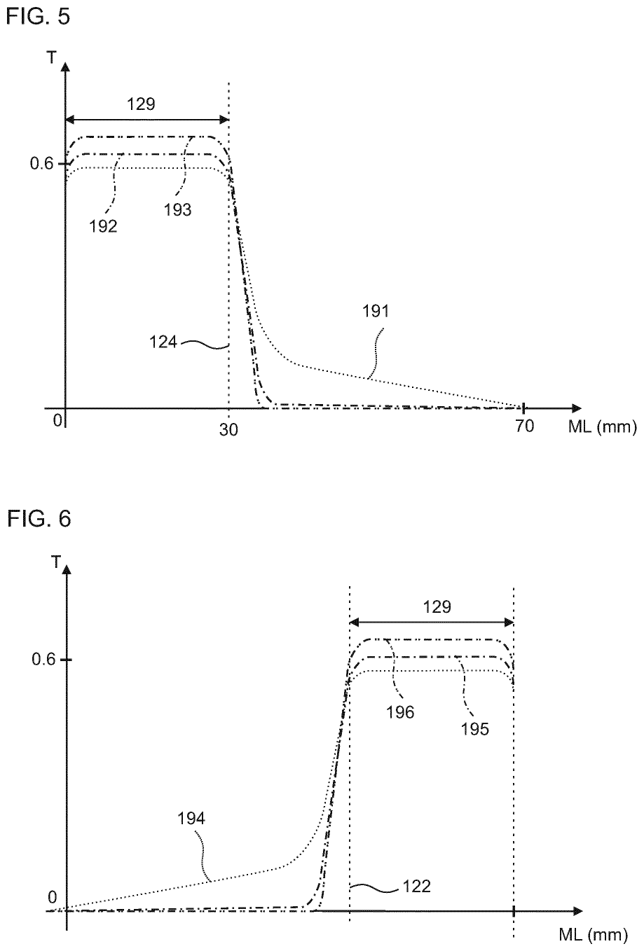

FIG. 5 is a graph illustrating the magnetic field plotted along a middle line ML of the deflection gap of a magnetic sector. An illustrative middle line ML is provided in FIG. 4. The magnetic sector may be identical to the ones as described in the previous figures. The current graph highlights the magnetic field variations in the deflection gap 129, and in environment of the magnetic sector after escape from the outlet face 124.

A first dashed line 191, or first curve, illustrates the magnetic flux of a magnetic sector without magnetic shunt. The illustrative magnetic sector has the size of 30 mm with an air gap of 4 mm.

Both the pole-pieces and the yoke are made of Iron. A uniform magnetic field of about 0.59 T inside the air gap is generated. This uniform magnetic field starts dropping from about 5 mm inside the physical boundary of the air gap and gradually decreases to zero, or a negligible value, at a distance as far as more than 40 mm from the physical boundary. At 10 mm from the physical boundary, a fringe field of about 60 mT is still remained. This magnetic field represents about 10% of the uniform field strength, which is considered as an important percentage.

A second dashed line 192 illustrates the magnetic flux of a magnetic sector with a magnetic shunt in accordance with FIG. 2. A third dashed line 193 illustrates the magnetic flux of a magnetic sector with a magnetic shunt in accordance with FIG. 4. As apparent from the current graph, the invention strikingly reduces the magnetic flux downstream the outlet face 124. At about 7 mm, the magnetic flux is almost 0 T, or a negligible value.

FIG. 6 is a graph illustrating the magnetic field plotted along a middle line ML of the deflection gap of a magnetic sector. An illustrative middle line ML is provided in FIG. 4. The magnetic sector may be identical to the one as described in the previous figures. The current graph underlines the magnetic field variations upstream the inlet face 122. The magnetic flux is generally uniform the deflection gap 129.

A fourth dashed curve 194 illustrates the magnetic flux of a magnetic sector without magnetic shunt. This illustrative magnetic sector may be similar to the illustrative one of FIG. 5.

A fifth dashed line 195 illustrates the magnetic flux of a magnetic sector with a magnetic shunt in accordance with FIG. 3. A sixth dashed line 196 illustrates the magnetic flux of a magnetic sector with a magnetic shunt in accordance with FIG. 4.

As apparent from the current graph, the invention limits fringe field upstream the inlet face 122 of the magnetic sector. At about 7 mm before entrance, the magnetic flux is almost OT. By contrast, without the invention, the fringe field which results from magnetic leakage, remains important 40 mm upstream the inlet physical plane.

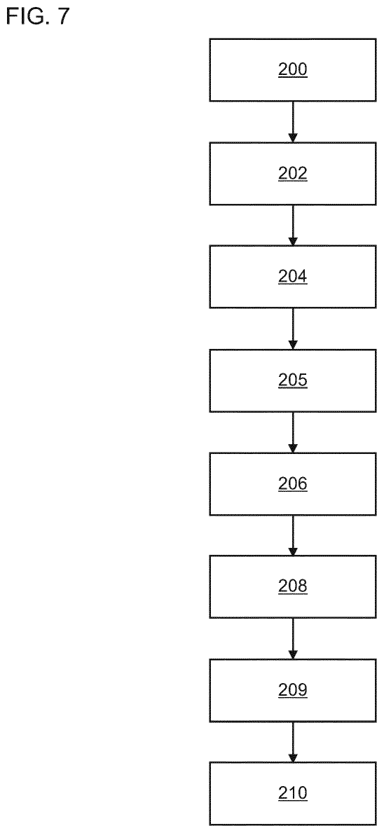

FIG. 7 illustrates a diagram of a charged particle deviation process by means of a magnetic sector. The magnetic sector may be similar or identical to those described in any of the previous figures, and combinations thereof.

The deviation process comprises the following steps:
providing 200 a magnetic sector including a yoke enclosing a first magnetic portion, and a deflection gap in the first magnetic portion;
providing 202 a second magnetic portion comprising a magnetic shunt magnetically coupled to the first magnetic portion,
generating 204 a magnetic field through the deflection gap,
moving 206 a charged particle through the deflection gap,
deflecting 208 the charged particle in the deflection gap by means of the magnetic field,
crossing 210 the magnetic shunt with the charged particle at a location outside the first magnetic portion.

The process may be a mass-to-charge ratio measuring process.

At step providing 200, the magnetic sector may be part of spectrometer device. The spectrometer device may be in accordance with the teaching of FIG. 1.

Before step moving 206, the charged particle deviation process may further comprise a step entering 205 the yoke during which the charged particle crosses the inlet magnetic shunt.

After step deflecting 208, the charged particle deviation process may further comprise a step leaving 209 the yoke during which the charged particle crosses the outlet magnetic shunt.

Preferably, at step crossing 210, the magnetic field in the shunt represents at most 5% of the magnetic field in the yoke.

Preferably, the shunt comprises a magnetic saturation threshold, and at step crossing the shunt comprises a magnetic field of at least: 50%, or 80%, or 90% of the magnetic saturation threshold.

As an option or an alternative, step crossing 210 is (also) before step moving 206 and before step deflecting 208. This steps definition occurs when the magnetic sector comprises an inlet shunt, or the combination of an inlet shunt and an outlet shunt.

In the current description, the features defined in relation with the inlet magnetic shunt and/or the outlet magnetic shunt also apply to the third shunt, unless the contrary is explicitly mentioned.

It should be understood that the detailed description of specific preferred embodiments is given by way of illustration only, since various changes and modifications within the scope of the invention will be apparent to the person skilled in the art. The scope of protection is defined by the following set of claims.

1. A magnetic sector, comprising:
magnetic means,
a yoke including a first magnetic portion, and a second portion comprising a magnetic shunt;
a deflection gap in the first magnetic portion; the magnetic sector being configured such that the magnetic means are adapted for generating a magnetic field through the deflection gap in order to deflect charged particles moving in said deflection gap, wherein the magnetic shunt comprises a shunt passage for the charged particles to pass across the magnetic shunt, and wherein the magnetic shunt is arranged for directing a magnetic flux leaked from the deflection gap into the first magnetic portion.

2. The magnetic sector in accordance with claim 1, wherein the magnetic shunt is arranged at a distance from and faces the first magnetic portion.

3. The magnetic sector in accordance with claim 1, wherein the yoke comprises magnetic connection means for magnetically coupling the magnetic shunt to the first magnetic portion.

4. The magnetic sector in accordance with claim 1, wherein a ratio of a width of the deflection gap divided by a thickness of the magnetic shunt is at least 4; the thickness of the magnetic shunt ranging from 0.3 mm to 3 mm.

5. The magnetic sector in accordance with claim 1, wherein the magnetic sector comprises an inner separation between the first magnetic portion and the magnetic shunt, the inner separation extending between the deflection gap and the shunt passage.

6. The magnetic sector in accordance with claim 5, wherein a ratio of an inner width of the inner separation divided by the thickness of the magnetic shunt is from 4 to 10.

7. The magnetic sector in accordance with claim 5, wherein the inner width of the inner separation ranges from 2 mm to 6 mm.

8. The magnetic sector in accordance with claim 1, wherein the magnetic shunt comprises at least one magnetic plate that is perpendicular to the deflection gap, said at least one magnetic plate defining the shunt passage.

9. The magnetic sector in accordance with claim 8, wherein the magnetic shunt comprises at least one branch which is inclined with respect to the at least one magnetic plate and which extends toward the deflection gap, wherein the magnetic shunt comprises two branches, wherein the at least one magnetic plate includes a first magnetic plate and a second magnetic plate, said branches extending from the respective magnetic plates toward the deflection gap.

10. The magnetic sector in accordance with claim 9, wherein an inclination angle between the at least one branch and the at least one magnetic plate ranges from 45° to 60°.

11. The magnetic sector in accordance with claim 1, wherein the magnetic means comprise at least one of at least one permanent magnet and at least one coil.

12. The magnetic sector in accordance with claim 11, wherein the coil extends on a majority of a space between the first magnetic portion and the magnetic shunt.

13. The magnetic sector in accordance with claim 1, wherein the magnetic shunt is a first magnetic shunt, arranged at an outlet face and the magnetic sector further comprises a second magnetic shunt at an inlet face, said second magnetic shunt being configured for directing a magnetic flux leaked from the deflection gap in the first magnetic portion.

14. The magnetic sector in accordance with claim 13, wherein the magnetic sector further defines an opposite face at an opposite of the inlet face, wherein the magnetic sector further comprises a third magnetic shunt at the opposite face, the third magnetic shunt being symmetrical to the inlet shunt.

15. The magnetic sector in accordance with claim 1, wherein the yoke comprises a main magnetic circuit in the first magnetic portion and at a distance from the magnetic shunt, and an auxiliary magnetic loop through the magnetic shunt and the first magnetic portion.

16. The magnetic sector in accordance with claim 1, wherein the magnetic sector comprises two pole pieces, the deflection gap being between said two pole pieces.

17. The magnetic sector in accordance with claim 16, wherein an inner width of the shunt passage represents 100% of an inner width of the deflection gap.

18. The magnetic sector in accordance with claim 17, wherein the yoke, the pole pieces, and the magnetic shunt comprise a similar magnetic material, the pole piece comprising said similar magnetic material, and a width of the deflection gap is equal to a width of the shunt passage.

19. A magnetic sector mass spectrometer, comprising:
an ion source;
an electrostatic sector;
a magnetic sector mass analyser; and
at least one detection system, wherein the magnetic sector mass the magnetic sector in accordance with claim 1.

20. A particle deviation process, to a comprising the steps:
providing a magnetic sector in accordance with claim 1;
generating a magnetic field through the deflection gap;
moving a charged particle through the deflection gap;
deflecting the charged particle in the deflection gap by means of the magnetic field; and
crossing the magnetic shunt with the charged particle outside the first magnetic portion.

21. The charged particle deviation process in accordance with claim 20, further comprising:
entering the yoke during which the charged particle crosses the magnetic shunt; and
leaving the yoke during which the charged particle crosses the magnetic shunt.

22. (canceled)

23. (canceled)
